(19) United States
(12) Patent Application Publication
(10) Pub. No.: US 2009/0300169 A1
(43) Pub. Date: Dec. 3, 2009

(54) SYNCHRONIZATION THROTTLING BASED ON USER ACTIVITY

(75) Inventors: Akash Jeevan Sagar, Redmond, WA (US); Vladimir D. Fedorov, Bellevue, WA (US); Muthukaruppan Annamalai, Bellevue, WA (US); Richard Y. Chung, Bothell, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/131,942

(22) Filed: Jun. 3, 2008

(51) Int. Cl. G06F 15/173

(52) U.S. Cl. 709/224

(57) ABSTRACT

Synchronization of data across multiple endpoints in a mesh network that supports a data sharing service is throttled responsively to user activity in the network by monitoring the activity using a component in a mesh operating environment (“MOE”) runtime that is instantiated on each endpoint. The monitoring may include the collection of data that can be used to infer user activity, as well as data that explicitly indicates activity. State information is maintained so that data can be synchronized across the endpoints even when a user goes offline from the service. When the user logs on to the service, makes changes to a shared file, or the endpoint device starts up upon connection to a mesh network, throttling is performed by prioritizing work items associated with synchronization operations so that resources on the endpoint are not excessively consumed which could reduce the quality of the user experience.

### BACKGROUND

During approximately the last 30 years dramatic advances in technology—for example, the development of the minicomputer, the rise of the personal computer, and the emergence of the Internet—have revolutionized the way information is created, stored, shared, and used. Today, as technology continues to advance and improve, new breakthroughs are transforming the world once again. The foundation for the current transformation is the combination of an increasing diversity of ever more powerful devices, and the expanding data storage capacity in large scale networked data centers (“the cloud”) that are accessed through the growing ubiquity of broadband networks that comprise the Internet. The capabilities of such technologies are supporting the movement of computing resources, including both consumer and business-oriented applications, from the desktop or enterprise environment out to the Internet as hosted services.

Under such a cloud-computing model, locally installed software on a client platform may be replaced, supplemented, or blended with a service component that is delivered over a network. Such models can often give customers more choices and flexibility by delivering software solutions and user experiences that can typically be rapidly deployed and accompanied by value-added services. In addition to providing application services, cloud-based computing can also provide data sharing and storage capabilities for users to access, collaborate in, and share rich data that leverages the global cloud-computing footprint. Data is synchronized through the service so that files and folders, for example, are commonly replicated across the devices.

While service platforms in the cloud are expected to provide attractive, feature-rich solutions to customers that are well managed, robust, and cost-effective, it is desirable to have effective and efficient ways to synchronize data between client devices and the cloud-based service. In particular, it would be desirable to be able to perform synchronization quickly while preventing the consumption of so many resources that the client device becomes unresponsive to the user. However, these requirements often conflict with each other particularly when a device is starting up. If it has been offline for some time, and a lot of data needs to be replicated, the synchronization process can slow the startup (i.e., boot) process which can lengthen the time that the device is unusable before applications become available and the user can begin to work.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

Synchronization of data across multiple devices which function as endpoints in a mesh network that supports a data sharing service is throttled responsively to user activity in the network by monitoring the activity using a component in a mesh operating environment (“MOE”) runtime that is instantiated on each endpoint. The monitoring may include the collection of data that can be used to infer user activity in the mesh network, as well as data that explicitly indicates activity. State information is maintained so that data can be synchronized across the endpoints even when a user goes offline from the service. When the user logs on to the service, makes changes to a shared file, or the endpoint device starts up upon connection to a mesh network, for example, throttling is performed by prioritizing work items associated with synchronization operations so that resources on the endpoint are not excessively consumed which could reduce the quality of the user experience.

In various illustrative examples, higher priority is assigned to synchronization operations for users who are currently logged on to the service on the mesh network, while lower priority is assigned to users who are not logged on. When no users are logged on, low priority is maintained for all synchronization operations. For currently logged on users, the synchronization operations can be throttled up or down depending on the monitored user activities. For example, calls to the MOE runtime and file system operations may be tracked and used as hints to identify other data, such as files in a common folder, which may be needed by the user which can then be given higher priority for synchronization. In this case, operations like data fetching from a peer endpoint will be given priority to ensure that the folder is kept up to date.

Conversely, when monitored system processes indicate a high level of resource use but such processes are not associated with the data sharing service (for example, a user may be performing a task such as editing a video that is computationally intensive), then synchronization operations can be given lower priority to free up resources to maintain a good user experience at the endpoint. In other examples, certain synchronization processes that are computationally intensive, such as hash calculations used to maintain data security, may be delayed to allow the user to complete activities such as edits to a file. Synchronization operations can then be performed later, rather than attempting to keep up with the user with each change to the file.

During startup of an endpoint, synchronization may be more heavily throttled when resources are typically consumed at peak rates. However, by using historical user activity patterns that may be persisted in a data store, the data that is most likely to be needed first by the user after startup is completed can be synchronized with the highest priority. By reducing the consumption of resources through throttling, the startup can complete more quickly which reduces the time that the endpoint is unusable. When the startup is completed and the user's desktop applications become ready for use, the data and files that the user needs to begin work will already be synchronized and current on the endpoint.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative cloud-computing environment in which the present synchronization throttling arrangement may operate;

FIG. 2 shows how resources exposed by a cloud-based platform service are illustratively arranged with client devices (called endpoints) into meshes;

FIGS. 3 and 4 show an illustrative mesh in which a file folder is shared and synchronized among multiple endpoints;

FIG. 5 is a flowchart of illustrative data synchronization operations;

FIG. 6 shows an architecture for an illustrative endpoint that is operatively coupled to a cloud service;

FIG. 7 shows functional details of operations performed by components of a mesh operating environment runtime in an endpoint; and

FIG. 8 is a flowchart of an illustrative method for throttling synchronization based on user activity.

Like reference numerals indicate like elements in the drawings.

### DETAILED DESCRIPTION

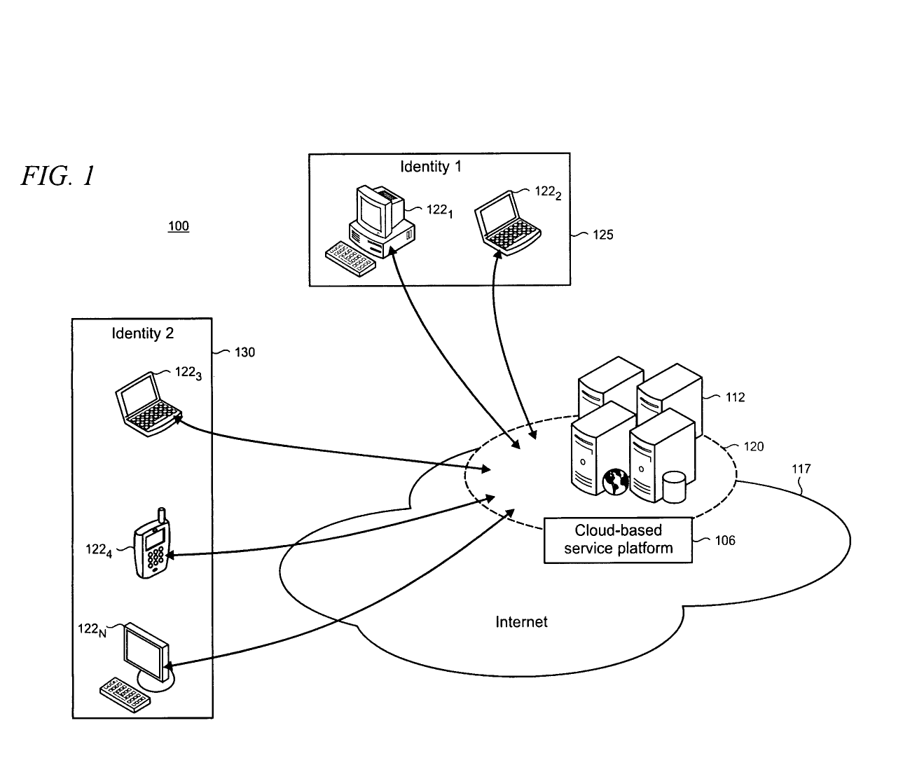

FIG. 1 shows an illustrative cloud-computing environment 100 in which the present synchronization throttling arrangement may operate. Environment 100 includes a cloud-based service platform 106 that exposes resources 112 to be accessed by client devices and users as a service over a network such as the Internet 117. A cloud-computing service (hereinafter referred to as a “cloud service”) is indicated in the abstract in FIG. 1 by the dashed oval 120. By utilizing typically large scale data centers and associated network infrastructure (which together form the “cloud”), the cloud-based service platform 106 may provide a virtualized computing application layer that supports an implementation of a variety of service offerings under, for example, the “software as services” or “software plus services” models.

Cloud service 120 may replace, supplement, or blend with features and capabilities provided by applications and software that run locally. Offerings may include, for example one or more of identity and directory services, device management and security, synchronized storage and data services across multiple devices or platforms, and services pertaining to activities and news. The cloud service 120 may be provided under a variety of different business models including free, advertising-supported, and subscription-based models.

As shown in FIG. 1, a group comprising N different endpoint devices 122 (referred to simply as “endpoint(s)”) is present in the environment 100. In this example, a user has a PC 122₁ and a portable laptop computer 122₂ that are arranged to access the service resources 112 exposed by the cloud-based service platform 106 under the user's credentials, or identity (as indicated by reference numeral 125), which is trusted by the cloud service 120. Another user maintains a trusted identity 130 so that the user may couple a laptop computer 122₃, a mobile device 122₄, and a PC 122_{N} to the Internet 117 to utilize the cloud service 120.

The endpoints 122 shown in FIG. 1 can typically be expected to have differing features and capabilities which may vary widely in some cases. For example, the PCs 122₁ and 122_{N} may utilize different operating systems, respectively, including the Microsoft Windows® operating system and the Apple Mac OS® operating system. In addition, the portable device 122₄ will typically be configured with fewer resources such as processing power, memory, and storage compared to the PCs and laptops and will use a different operating system.

It is emphasized that the endpoints shown in FIG. 1 are merely illustrative and a variety of different endpoint devices may be utilized with the present synchronization throttling arrangement. These include for example, media center PCs, game consoles, set-top boxes, ultra-mobile computers, handheld game devices, mobile phones, PDAs (personal digital assistants), pocket PCs, personal media players such as MP3 players (Moving Pictures Expert Group, MPEG-1, audio layer 3), and similar devices.

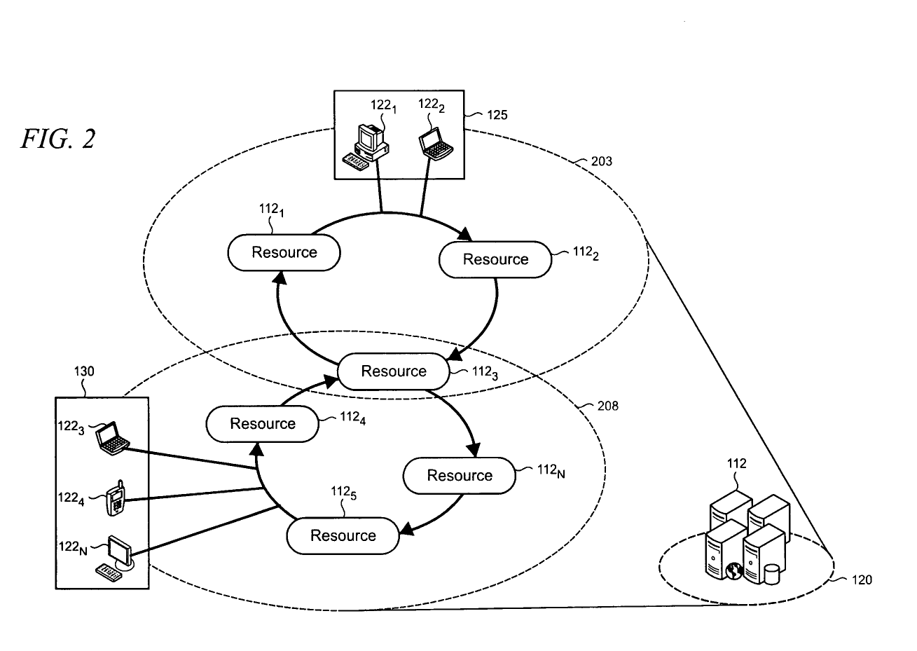

As shown in FIG. 2, the resources 112 that are exposed by the cloud service 120 may be logically arranged to form meshes. In this example, a mesh is associated with each of the identities 125 and 130 (and the endpoints 122 associated therewith) as respectively indicated by reference numerals 203 and 208. The meshes include those resources which are utilized to implement a given service offering for the user and the endpoints which are associated with and can access the resource. In this example, resources 112₁, 112₂, and 112₃ are associated with the user having identity 125 and the endpoints 122₁ and 122₂ in mesh 203. The user having identity 130 receives services that are implemented with mesh 208 which includes resources 112₃, 112₄, 112₅ and 112_{N} that are accessible to the user's devices 122₃, 122₄, and 122_{N}. As shown, an endpoint 122 can traverse a mesh and move from resource to resource in order to gain access to a desired service 120. The endpoints 122 may be viewed as peer devices on the mesh where data may be moved across the devices (i.e., fetched) as required to effectuate the service 120.

Meshes can overlap as shown in FIG. 2. In this example, resource 112₃ is commonly utilized in both meshes 203 and 208. Resource 112₃ could be, for example, a folder to which one user as an owner has given another user permission to access as a member. It is noted that the number and configuration of resources shown here in this example are arbitrary, and the particular resources used in a given mesh to implement a specific service offering for a user can be expected to vary to meet the needs of a particular scenario.

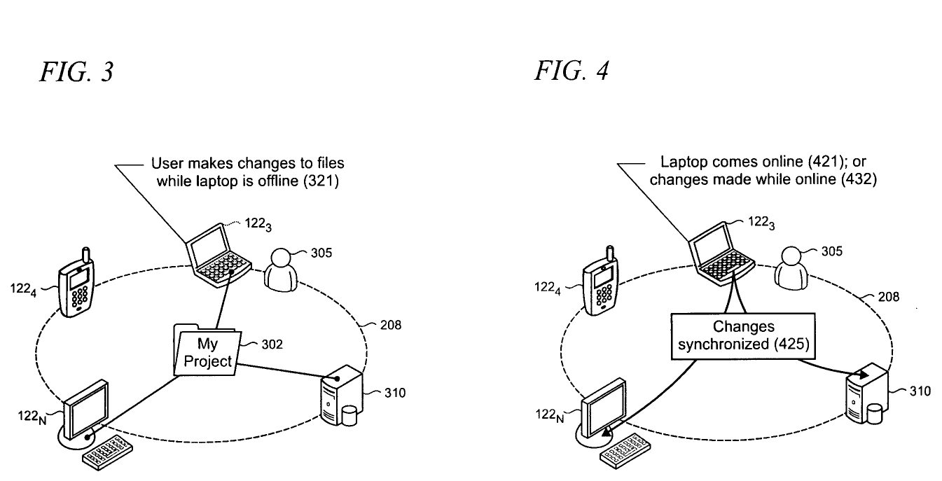

FIG. 3 shows the illustrative mesh 208 in which a file folder 302 named “My Project” has been designated by the user 305 associated with the mesh as a shared folder that should be synchronized across a variety of endpoints 122 as part of a data sharing service. In this example, the folder 302 is shared between the user's desktop PC 122_{N} and the laptop computer 122₃. The user 305 has also designated the folder 302 to be replicated in the cloud (i.e., also stored on a storage server 310 provided by the service 120).

The user 305 makes changes to a file in the folder 302, in this example, when the laptop computer 122₃ is offline (as indicated by reference numeral 321), perhaps during an airplane flight in which network connectivity is normally unavailable. As shown in FIG. 4, when the user 305 gets to his destination and gets network connectivity to come online with the service 120 (421), the changes to the file in the folder 302 made during the flight will get synchronized across the desktop PC 122_{N} and the server 310 (425). If the user 305 continues to edit the file while online (432), those changes will also be synchronized across the desktop PC 122_{N} and server 310. Accordingly, even though the user 305 is not signed-in to the service 120 while on the airplane, state information about the laptop computer 122₃ is still maintained.

Returning to FIG. 3, by making the folder 302 available on the server 310, the user 305 is enabled with access, from other locations and using other devices, to files in the folder (such as documents, pictures, etc.). For example, the user 305 can access and make changes to a file in the folder 302 while working at a PC at a public library or Internet cafe. The changes will then be synchronized, in a similar manner as described above, across the endpoints 122₃ and 122_{N} so that the file will be current when the user returns back home and works on the file again on the desktop PC. Accordingly, the cloud-based folder 302 may be used to support a virtual endpoint in the mesh 208. In the Microsoft Windows Live Mesh™ service, such a virtual endpoint is called the “Live Desktop.”

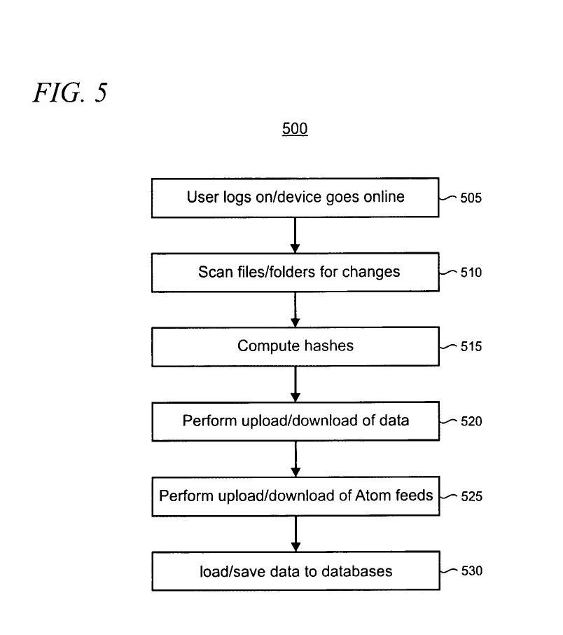

Illustrative synchronization operations 500 that are generally performed by an endpoint 122 are shown in FIG. 5. Synchronization may begin once a user 305 logs on to the service 120 or an endpoint 122 otherwise goes online (505). All instances of the folder 302 and its included files will be scanned for changes (510) and hashes for the changed data will be computed (515). Cryptographic hashing is a known technique that is often utilized to uniquely identify data, and is used here to ensure that the correct data is replicated over the service to the endpoints 122.

Data is respectively uploaded and/or downloaded (520) as required to replicate data identically across the endpoints 122. In this example, synchronization is implemented using a collection of two way Atom feeds in which data in the user's mesh 208 (e.g., file, folder, message, etc.) is rendered as a piece of information in the feed. Alternatives to the Atom feed include feeds expressed using RSS (Really Simple Syndication), JSON (JavaScript Object Notation), Microsoft FeedSync (formerly known as Simple Sharing Extensions or “SSE”), WB-XML (wireless binary extensible markup language), and POX (plain old XML). The Atom feeds provide a common synchronization infrastructure for the mesh 208 between applications on the endpoints and the service 120. Such feeds are also commonly used to support synchronization of non-mesh applications such as e-mail, and news readers, for example. Accordingly, upload and download of Atom feeds are also performed (525). Data describing synchronization state may also be loaded and/or saved to databases as required to perform the synchronization process (530). It is noted that the synchronization operations 500 are illustrative and that the particular operations and the order in which they are performed may vary to meet the needs of a given implementation. To cite just one example of such variation, the data uploading/downloading (520) and the Atom feed uploading/downloading (525) may be performed in reverse order to that shown in FIG. 5, or be performed in parallel in some cases.

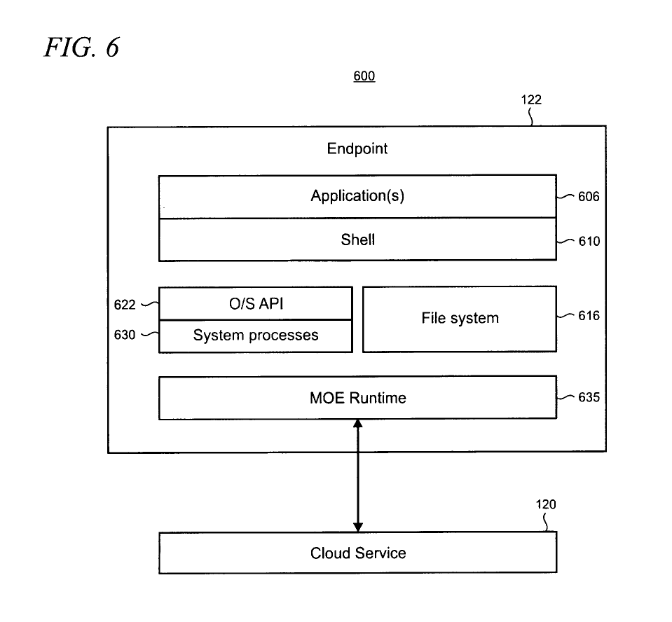

An illustrative software architecture 600 for a representative endpoint 122 is shown in FIG. 6 which includes several functional components including one or more applications 606, shell 610 (i.e., a specialized application that provides a user interface or desktop on the device), file system 616, operating system API 622 (application programming interface) that is configured to expose system processes 630, and an instance of a mesh operating environment (“MOE”) runtime 635. Applications 606 may include any of a variety of typical applications that may run on an endpoint device to enhance productivity (e.g., word processing, spreadsheets), support communications (e.g., e-mail, web-browsing, and instant messaging), provide entertainment (e.g., games, multimedia players), and the like.

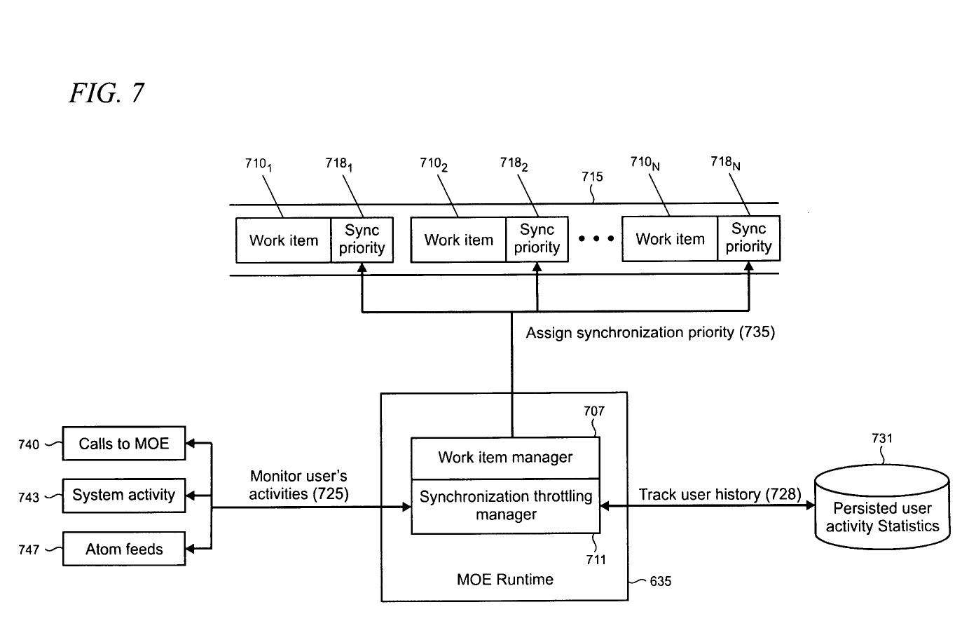

The MOE runtime 635 is generally configured to expose services to help the applications 606 running on endpoints 122 to create cached or offline-based experiences to reduce round trip interactions with the cloud service 120 or to enable the endpoints to morph data into a more consumable form. More specifically, as shown in FIG. 7, the MOE runtime 635 includes functional components which comprise a work item manager 707 and a synchronization throttling manager 711.

The work item manager 707 interacts with work items 710_{1, 2 . . . N} that represent events that occur in association with synchronization operations in the endpoint 122. Such operations may include, for example, those shown in FIG. 5 and described in the accompanying text. The work items 710 are queued in a work item queue 715 and are serviced from the queue for processing based on synchronization priority 718_{1, 2 . . . N} that are associated with respective work items. Synchronization priorities 718 could be represented, for example, by a numeric value with higher values indicating higher priority for work item processing and lower values indicating lower priority. Thus, data associated with higher priority work items will get synchronized before data that is associated with lower priority work items.

The synchronization throttling manager 711 is configured to interoperate with the work item manager 707 by monitoring user activity at the endpoint 122 (as indicated by reference numeral 725), as well as tracking user activity (728) in the form of historical statistics that are persisted to a store 731. In response to the monitoring and tracking performed by the synchronization throttling manager 711, the work item manager 707 will assign a synchronization priority 718 to the work items 710 (735).

The monitoring 725 may comprise collecting data that may be used to infer activity of a user 305, as well as data that explicitly indicates such activity. In the first case, by monitoring the API calls from the applications 606 to the MOE runtime 635 (740), and tracking the data that the applications access, hints as to what other data will be accessed by the user 305 may be ascertained. That is, the calls and data will implicitly indicate which object in the user's mesh 208 is currently being used by the user 305.

For example, if the user is browsing the files in the “My Project” folder 302 on his desktop, the shell 610 is the application that will be making calls to the MOE runtime 635. The user 305 may then start up a word processing application and begin to make edits to a particular file in the folder 302. By monitoring this user activity, the synchronization throttling manager 711 may infer that other files in the folder 302 will also be accessed and/or edited by the user 305. Accordingly, the work item manager 707 may raise the priority of work items 710 associated with the synchronization of the files in the folder 302 so that synchronization of the files takes priority over other operations.

Another example of implicit indications of user activity may come from the monitoring of activity at the system level on the endpoint 122 (743). This may be implemented, for example, by using the APIs 622 provided by the operating system on the endpoint 122 to expose system processes, such as hard disk activity, to the synchronization throttling manager 711. Operations and actions of the file system 616 may be similarly monitored. In this case, if there is a lot of disk access or file system operations that are not related to an object in the user's mesh 208, such activity may be used by the synchronization throttling manager 711 to infer that the user 305 is doing something that is reasonably computationally expensive.

For example, the user 305 may be doing some video editing or recalculating a large spreadsheet using one or more applications 606. The work item manager 707 could then lower the priority of work items 710 so that synchronization operations do not put additional pressures on system resources which may already be being consumed at a high level.

With regard to explicit indications of user activity, the synchronization throttling manager 711 may also monitor Atom feeds (747). Atom feeds, as described above, support the underlying synchronization infrastructure for the resources on the user's mesh 208 in this implementation. The monitoring of the Atom feeds may provide, for example, information about other users' activities on other remote endpoints by an application firing an event across the mesh 208 to explicitly indicate that another user has entered the folder 302 (typically with permission of the owner) and is now browsing the files contained therein. The work item manager can use this explicit information to increase the priority of work items 710 associated with synchronization of the files in this case.

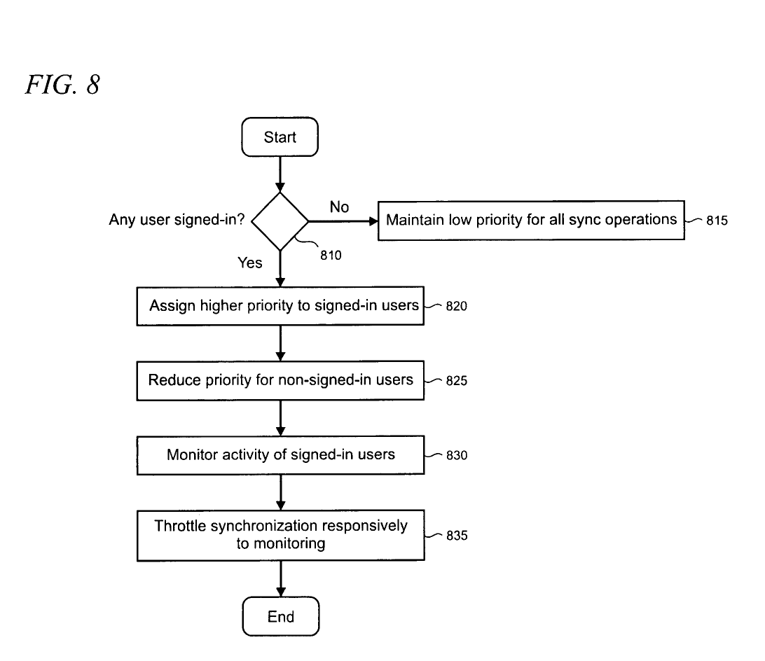

Turning now to FIG. 8, a flowchart of an illustrative method for throttling synchronization based on user activity is shown that is applicable to the present arrangement as shown in FIGS. 1-7 and described in the accompanying text. The synchronization throttling is based on user activity and, depending on whether any user is signed-in to the service 120 (810), will either be maintained at a low priority (815) for all synchronization operations 500 or involve different levels of throttling. As shown, currently signed-in users will have relatively higher priority assigned to the synchronization of their data (820) while users who are not signed-in to the service 120 will have reduced priority (825).

For the signed-in users, their activities will be monitored (830), and synchronization throttled (835) responsively to such monitoring. Examples of the synchronization throttling include the delaying of computationally-intensive hash calculations in some cases. If the user is actively editing a document in the folder 302 which results in quick succession of events from the file system 616, the hashes may be delayed so that a set of user's changes are incorporated as using hashing performed in a batch process, for example. Another example is that the synchronization throttle may be opened when a user is actively browsing the folder 302. In this case, the priority of the Atom feed upload/download operation 525 may be increased as well as the priority for any associated peer-to-peer data fetching from remote endpoints 122 (i.e., upload/download data operation 520).

Throttling may also be performed during startup of an endpoint 122, particularly as there can be many pending changes in data that need to be synchronized from when the endpoint was offline. But as system resources are typically consumed at peak rates during startup, performing synchronization operations without throttling can often be expected to increase startup (i.e., boot) time which can undesirably lengthen the period of time before applications become available and the endpoint device becomes usable.

The solution in this case is to throttle all synchronization operations at startup including loading/saving data to databases 530, file/folder scanning 510, etc., in view of the user's historical activity that is persisted as statistics in the store 731. This enables early synchronization of data that, according to historical trends, is more likely to be accessed by the user upon log-on while also reducing the potential for conflicts that may be generated when the user attempts to modify data that has yet to be synchronized.

For example, historical activity might indicate that the user 305 has been working out of the My Project folder 302 consistently over the course of several days, and perhaps starts and ends a given work session by editing files in the folder 302. In this case, the folder 302 will be given the highest priority for synchronization so that the user's files will be current at whatever endpoint device the user employs for the next log-on. In cases where the activity history is not as clear cut, known statistical analyses may be applied to identify the most likely data candidates to be given high priority for synchronization.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An automated method for managing a user experience at an endpoint of a mesh network, the method comprising the steps of:
monitoring user activity at the endpoint of the mesh network, the mesh network supporting a cloud-based data sharing service through which one or more users may share data from user-designated resources, the data being synchronized across a plurality of endpoints on the mesh network;
establishing prioritization, responsively to the monitoring, for synchronization operations to be performed on the shared data; and
throttling the synchronization operations in accordance with the prioritization so that resources on the endpoint are consumed in a manner that optimizes the user experience.

2. The automated method of claim 1 in which the user-designated resources comprise files or folders.

3. The automated method of claim 1 including a further step of monitoring explicit API calls made by an application on an endpoint that indicate activity of a user with respect to a resource.

4. The automated method of claim 1 including a further step of inferring user activity by monitoring system processes being performed on an endpoint.

5. The automated method of claim 4 in which the system processes include at least one of file system operations or hard disk access.

6. The automated method of claim 1 in which the synchronization operations include at least one of scanning a file or a folder for changes, computing a hash, performing uploading or downloading of data, performing uploading or downloading of data feeds from the service, or loading or saving data to a database.

7. The automated method of claim 1 in which the throttling comprises at least one of delaying a hash computation, increasing prioritization of data fetching from a peer endpoint, or increasing prioritization of uploading pending local changes.

8. The automated method of claim 1 including the further steps of persisting historical user activity and using the persisted historical user activity to identify data having a likelihood of being needed by the one or more users.

9. The automated method of claim 8 including a further step of establishing prioritization using the persisted historical user activity.

10. The automated method of claim 8 in which the data is identified using statistical analysis.

11. A computer-readable medium containing instructions which, when executed by one or more processors disposed on an electronic device, implement a mesh operating environment runtime, comprising:
a synchronization throttling manager configured for monitoring user activity at an endpoint on a mesh network, the mesh network supporting a cloud-based data sharing service through which one or more users may share data from user-designated resources, the data being synchronized across a plurality of endpoints on the mesh network; and
a work item manager operatively coupled to the synchronization throttling manager and configured for assigning prioritization to work items associated with operations for synchronizing replicated data across a plurality of endpoints on the mesh network, the work items being processed in accordance with the prioritization.

12. The computer-readable medium of claim 11 in which the synchronization throttling manager and work item manager are each configured as components of a mesh operating environment runtime that is instantiated on each of the endpoints on the mesh network.

13. The computer-readable medium of claim 11 in which the work items are processed from a work item queue.

14. The computer-readable medium of claim 11 in which the synchronization throttling manager is further configured for tracking historical user activity.

15. The computer-readable medium of claim 11 in which the electronic device is selected from a group consisting of PCs, set-top boxes, game consoles, laptop computers, pocket PCs, PDAs, smart phones, mobile phones, portable media players, handheld game devices, ultra-mobile computers, or devices comprising a combination of features provided therefrom.

16. A method performed at least in part by a computer in a cloud-based data sharing service, the method comprising the steps of:
providing feed data to implement synchronization infrastructure among endpoints in a mesh network over which the cloud-based data sharing service is operated;
maintaining a virtual endpoint on the cloud-based data sharing service that is accessible by a user at a remote device; and
synchronizing data to and from the virtual endpoint using the infrastructure based upon a priority assignment made at one of the endpoints, the assignment based on user activity that is monitored by the endpoint.

17. The method of claim 16 in which the remote device accesses the virtual endpoint over the Internet.

18. The method of claim 16 in which the virtual endpoint supports a resource that is shareable with the endpoints, the resource being one of file, folder, or message.

19. The method of claim 16 in which the endpoint monitors the user activity using a mesh operating environment runtime.

20. The method of claim 16 in which the feed data is expressed using one of Atom, JSON, FeedSync, RSS, WB-XML, or POX.
